(19) United States
(12) Patent Application Publication
(10) Pub. No.: US 2020/0354143 A1
(43) Pub. Date: Nov. 12, 2020

(54) INFLATABLE BLADDER SYSTEM FOR BULK LIQUID TRANSPORT

(71) Applicant: Scott Houle, Nashua, NH (US)

(72) Inventor: Scott Houle, Nashua, NH (US)

(21) Appl. No.: 16/858,411

(22) Filed: Apr. 24, 2020

Related U.S. Application Data
(60) Provisional application No. 62/844,203, filed on May 7, 2019.

(51) Int. Cl. B65D 90/52; G05D 16/20; B65D 88/22

(52) U.S. Cl. CPC B65D 90/52; B65D 88/22; G05D 16/204

(57) ABSTRACT

A system (typically on a bulk liquid transport vehicle) includes a liquid storage tank, one or more liquid storage compartments inside the liquid storage tank, an inflatable bladder inside each of the liquid storage compartments, a compressed air system to provide compressed air to inflate each one of the inflatable bladders, and one or more valves. Each of the valves is configured to control air flow between the compressed air system and a corresponding one of the inflatable bladders and/or to control air flow between the corresponding inflatable bladder and atmosphere.

### CROSS-REFERENCE TO RELATED APPLICATION(S)

This application claims the benefit of U.S. Provisional Patent Application Ser. No. 62/844,203, filed May 7, 2019, and entitled INFLATABLE BLADDER SYSTEM FOR BULK LIQUID TRANSPORT. The disclosure of the prior application is incorporated by reference herein in its entirety.

### FIELD OF THE INVENTION

This application relates to an inflatable bladder system and more particularly relates to an inflatable bladder system for use in connection with the bulk liquid transport industry.

### BACKGROUND

Surge and slosh are big problems in the bulk liquid transport industry. When a vehicle hauling a trailer carrying liquid is slowed down, for example, the liquid being carried tends to continue moving forward even though the vehicle is slowing down. This continued movement can create a force that tends to make safely braking more difficult. This is true even to some extent even if the trailer has one or more internal baffles to temper the effect. Moreover, even when stopped, the liquid may continue sloshing back and forth creating instability and making the vehicle more difficult to safely control.

### SUMMARY OF THE INVENTION

In one aspect, a system (typically on a bulk liquid transport vehicle) includes a liquid storage tank, one or more liquid storage compartments inside the liquid storage tank, an inflatable bladder inside each of the liquid storage compartments, a compressed air system to provide compressed air to inflate each one of the inflatable bladders, and one or more valves. Each of the valves is configured to control air flow between the compressed air system and a corresponding one of the inflatable bladders and/or to control air flow between the corresponding inflatable bladder and atmosphere.

In another aspect, a system includes a liquid storage tank, a plurality of baffles inside the liquid storage tank, wherein the baffles divide the liquid storage tank longitudinally into a plurality of liquid storage compartments, an inflatable bladder inside each of the liquid storage compartments, a compressed air system configured to provide compressed air to inflate the inflatable bladders, and a plurality of valves, wherein each valve is configured to control air flow between the compressed air system and a corresponding one of the inflatable bladders and/or to control air flow between the corresponding inflatable bladder and atmosphere.

In some implementations, one or more of the following advantages are present.

For example, the systems and techniques disclosed herein are useful in the transportation industry, specifically liquid bulk transport. One feature that the inflatable bladders provide is to control or eliminate slosh and surge. How it works: inflating a bladder essentially makes any “half full” or “partially full” compartment, into a full (or more full) compartment. This helps reduce the potentially deleterious effects of liquid movement, including slosh and surge, in a tank being hauled.

In a typical implementation, the systems and techniques disclosed herein provide improvements over more traditional approaches including, for example, the use of traditional baffles and drop-in baffles.

Traditional baffles typically only REDUCE surge and slosh in a FRONT TO BACK motion, but have NO benefits for SIDE TO SIDE surge, which is felt while on turns, or in an emergency swerve situation.

Unlike baffles that rely on blocking surge and transferring it through the tank to the truck, drop-in baffles (for example Surge Buster® drop-in baffles) dissipate energy within the tank. Nothing is securely attached to the walls of the tank. The resulting benefit to the liquid load hauler is a safer load, reduced stress and fatigue on the driver, plus a reduction in vehicle maintenance cost as well as longer tank life. However, one problem with the drop-in baffles is that it can be impractical for everyday use. Generally, someone has to climb onto the top of the tank and be handed hundreds of these drop in baffles, just to make a difference. But then what? Then you have to fish them out? Clean them? Store them somewhere until next time? This can be time consuming and impractical. Additionally, even with these drop in baffles, there is still some front to back surge, as well as side to side surge.

Some benefits of certain implementations of the inflatable bladder system for liquid surge control disclosed herein include:
1. Liquid surge/loadshift reduction or elimination
2. Stabilization of liquid in the entire compartment, from all directions of force.
3. Stress reduction to the operator
4. Physical fatigue reduction to the truck frame, tank mounts, brakes and automatic transmissions
5. Beneficial in stopping/emergency or in frosty/icy conditions
6. Potential to help prevent accidents.
7. Stabilizing the liquid cargo is beneficial to maintenance reduction, and also increases the safety aspects of transporting liquid cargoes.
8. Improves Vehicle Safety and Control
9. Makes Hauling Liquids Easier
10. Reduces Rollover Potential Especially on Rough and Uneven Roads
11. Helps Company PR and Environmental Concerns by Lessening the Chance of Spills

Other features and advantages will be apparent from the description and drawings, and from the claims.

### BRIEF DESCRIPTION OF THE DRAWINGS

FIG. 1 is a partial schematic representation of a vehicle for transporting bulk liquids that includes a system for controlling undesirable surge of bulk liquid being transported by the vehicle.

FIG. 2 is a partial cut-away, perspective view showing inflatable bladders in a liquid storage compartment of a liquid storage tank, where the inflatable bladders are in a completely deflated configuration.

FIG. 3 is a partial cut-away, perspective view showing the inflatable bladders in the liquid storage compartment of the liquid storage tank of FIG. 2, where the inflatable bladders are partially inflated.

FIG. 4 is a partial cut-away, perspective view showing the inflatable bladders in the liquid storage compartment of the liquid storage tank of FIG. 2, where the inflatable bladders are in a slightly more inflated configuration than in FIG. 3, but still not completely inflated.

FIG. 5 is a partial cut-away, perspective view showing the inflatable bladders in the liquid storage compartment of the liquid storage tank of FIG. 2, where the inflatable bladders are completely inflated.

FIG. 6 is a side perspective view of an implementation of an inflatable bladder.

FIGS. 7A and 7B are perspective views showing exemplary implementations of solenoid valves from FIG. 1.

FIG. 8 is a perspective view showing part of the upper, outer surface of the liquid storage tank from FIG. 1.

FIG. 9 is a perspective view of a can box for the vehicle represented in FIG. 1.

FIG. 10 is a schematic representation of an exemplary user interface of a bladder control box.

FIG. 11 is a perspective view showing a top of a liquid tank trailer.

FIG. 12 is a perspective view showing one implementation of a pressure transducer for sensing pressure inside the inflatable bladders.

FIG. 13A is a partially-transparent, perspective view of a vehicle assembly that includes a bulk liquid storage tank.

FIG. 13B is a partially-transparent, side view of the vehicle assembly in FIG. 13A.

Like reference characters refer to like elements.

### DETAILED DESCRIPTION

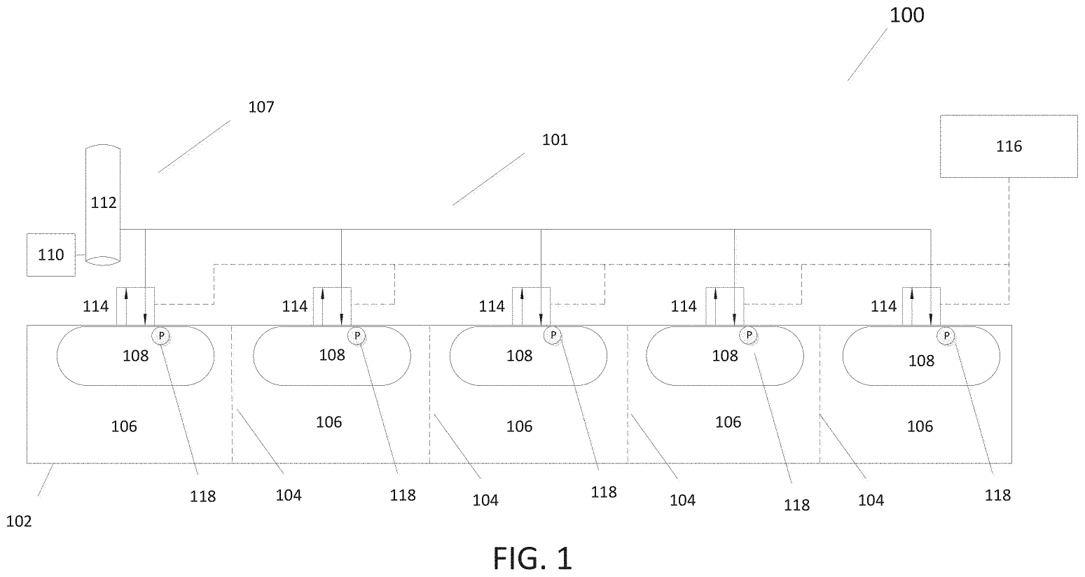

FIG. 1 is a partial schematic representation of a vehicle for transporting bulk liquids. More specifically, the vehicle represent in the illustrated implementation would have a tractor pulling a trailer (or some other means to roll along a road, for example). The trailer would be supporting bulk liquid storage tank 102.

Moreover, the illustrated vehicle 100 has an inflatable bladder system 101 for controlling undesirable movement (e.g., surge, slosh, etc.) of bulk liquid being transported within the tank 102. In a typical implementation, the inflatable bladder system 101 is able to control surge in virtually all directions, including longitudinally (i.e., defined by the vehicle's direction of motion) as well as laterally (i.e., side-to-side). Moreover, in a typical implementation, the inflatable bladder system 101 can control movement of the liquid anytime there is an amount of liquid in the tank 102 that has potential to create vehicle stability problems, regardless of whether the actual liquid level in the tank 102.

The system 101 in the illustrated implementation includes a plurality of baffles 104 (four in the illustrated implementation) that divide the tank 102 internally, in a longitudinal direction, into five discrete liquid storage compartments 106. Each baffle 104 laterally dissects the liquid storage tank 102. The internal baffles 104 are pretty evenly spaced so that each internal compartment 106 is about the same size as the others. The baffles 104 can take on any one of a variety of possible configurations. For example, in some implementations, the baffles 104 are solid barriers that completely isolate, and prevent the flow of liquid, between adjacent liquid storage compartments 106. In some implementations, the baffles 104 have one or more openings that may allow some, typically a small amount, of the liquid in one of the compartments to flow into and back from an adjacent one of the compartments. In a typical implementation, the baffles 104 help temper deleterious effects that liquid movement (e.g., surging or sloshing) in a longitudinal direction might have on vehicle stability.

An inflatable bladder 108 is inside each respective one of the liquid storage compartments 106. Each inflatable bladder 108 in the illustrated implementation is a hollow, flexible bag that can be inflated or deflated to fill more or less of its corresponding liquid storage compartment 106. In this regard, the vehicle has a compressed air system 107 that is configured to provide compressed air that can be introduced into the inflatable bladders 108 to inflate the inflatable bladders 108. Moreover, each inflatable bladder 108 can be deflated by releasing the compressed air from inside the inflatable bladder 108 (e.g., to atmosphere). The air released into the atmosphere would not include vapor from any of the liquids being stored in the liquid storage compartments 106, but is generally fresh air from within the inflatable bladders 108, which would have come from the vehicle's compressed air system.

The vehicle's compressed air system 107 includes an air compressor 110, a receiver tank 112 coupled to the air compressor 110, and pneumatic lines (e.g., tubes or pipes) to carry compressed air throughout the system 107 including for use in connection with inflating the inflatable baffles 108. The air compressor 110 can be virtually any kind of device that converts power (e.g., from an electric motor, diesel or gasoline engine, etc.) into potential energy stored in the form of pressurized air (i.e., compressed air). During operation, the air compressor typically forces air into the receiver tank 112, increasing pressure in the receiver tank 112 as more and more compressed air is introduced. In a typical implementation, when the pressure inside the receiver tank 112 reaches an upper limit the air compressor 110 shuts off. The compressed air, then, is held in the tank until called into use (e.g., to inflate one or more or all of the inflatable bladders or for some other purpose/application). As the compressed air is released from the receiver tank 112, the pressure inside the receiver tank 112 goes down. When the pressure inside the receiver tank 112 reaches a lower limit, the air compressor 110 turns on again and re-pressurizes the receiver tank 112. In a typical implementation, the receiver tank 112 acts as a reservoir of compressed air for peak demands, helps remove water from the system by allowing the compressed air a chance to cool, and minimizes pulsation in the compressed air system that might be caused, for example, by a reciprocating air compressor cycling on and off to meet a varying demand or by some cyclic process downstream of the air compressor.

The system 101 includes valves 114 that open and close to control air flow between the vehicle's compressed air system and the inflatable bladders 108 and control air flow between the inflatable bladders 108 and atmosphere. In some implementations, the valves 114 are solenoid valves. In some such implementations, each solenoid valve 114 has an inlet port that is connected to the vehicle's compressed air system, an outlet port that is connected to a corresponding one of the inflatable bladders 108, and a vent that provides a flow path from the corresponding inflatable bladder 108 to atmosphere.

Each solenoid valve 114 has a solenoid. A solenoid is a coil of wire, usually in a cylindrical form that acts as a magnet when carrying an electrical current. Typically, this magnetic action causes a ferromagnetic core, for example, to move relative to the coil, which can be used to control a mechanical device, such as the valve portion of the solenoid valve 114. A solenoid valve is a valve that has one or more solenoids that can act to cause the valve to open or close one or more flow paths through the valve.

In the illustrated implementation, each solenoid valve 114 is mounted on an upper, outer surface of liquid storage tank 102. In a typical implementation, each solenoid valve 114 would be next to an access manhole for the corresponding liquid storage compartment 106. The inflatable bladder 108 for that liquid storage compartment 106 is attached to the bottom of the solenoid valve 114 (inside of the liquid storage compartment 106). Typically, each opening in the liquid storage tank 102 that allows one of the inflatable bladders 108 to be attached to its corresponding solenoid valve 106 is sealed around the bladder 108, the solenoid valve 106, or both to prevent vapors or fluids from accidentally escaping the liquid storage tank 102 through the opening.

The system 101 also has a control box 116 with a user interface that enables a human user to selectively inflate or deflate any one or more or all of the inflatable bladders 108. In an exemplary implementation, the user interface might include five “fill/deflate” rocker switches or buttons—one for each inflatable bladder 108—that the user can manipulate to inflate or deflate any one or more, or all, of the inflatable bladders 108 with air. The control box 116 sends electrical signals to the solenoid valves 114 for the inflatable bladders 108, via electrically conductive wires (represented as dashed lines in the schematic illustration), to cause the solenoid valves 114 to behave in a variety of ways described herein.

For example, if the control box 116 sends a signal to a particular solenoid valve 114 indicating that a corresponding inflatable bladder 108 should be inflated, then that particular solenoid valve 114 would open a fluid flow path between its inlet port (connected to the compressed air system 107) and its outlet port (connected to the corresponding inflatable bladder 108) and also close its vent to atmosphere. Alternatively, if the control box 116 sends a signal to a particular solenoid valve 114 indicating that a corresponding inflatable bladder 108 should be deflated, then that particular solenoid valve 114 would open its vent to atmosphere and close (or keep closed) the flow path between its inlet port (connected to the compressed air system 107) and its outlet port (connected to the corresponding inflatable bladder 108).

According to some implementations, the user interface on the control box has rocker switches that can be manipulated by a user to inflate or deflate each of the inflatable bladders 108. In such implementations, if the user moves the rocker switch for one of the inflatable bladders 108 to a “fill” position, the control box 116 causes the associated solenoid valve 114 to move into configuration that results in air flowing from the vehicle's compressed air system into the inflatable bladder 108.

Typically, air continues to flow into the inflatable bladder 108 until the inflatable bladder 108 is sufficiently full (e.g., until the air inside the inflatable bladder 108 reaches a target pressure that indicates the inflatable bladder 108 is sufficiently full). In this regard, the system includes a pressure sensor 118 to sense pressure inside each respective one of the inflatable bladders 108. Each pressure sensor 118 in the illustrated implementation is shown as being inside each inflatable bladder 108. However, in some implementations, each pressure sensors 118 may be outside of its inflatable bladder, but connected (e.g., via an air pressure sensing line) to its inflatable bladder. In some implementations, the pressure sensors 118 may operate similar to a typical tire pressure monitoring system (TPMS) sensor which senses pressure on the inside of a tire.

In general, during inflation, as air is pushed into one of the inflatable bladder 108, the inflatable bladder 108 expands to occupy more and more of the volume inside its liquid storage compartment 106. Eventually, the expanding inflatable bladder 108 begins to press down on the liquid inside the liquid storage area, and the pressure inside the inflatable bladder rises.

The pressure sensors 118 in the illustrated system 101 may provide electrical signals to the control panel 116 indicative of the pressure being sensed. In a typical implementation, if a user has instructed the system 101 to inflate a particular inflatable bladder 108, the system 101 will deliver compressed air into that inflatable bladder 108 until the pressure in that inflatable bladder reaches some predetermined value (e.g., a target pressure, that may have been programmed into computer-based memory within or accessible from a control panel 116). If a computer-based processor (e.g., within or in communication with the control panel 116) determines that the pressure inside one of the inflatable bladders 108 has reached the predetermined value, the processor causes the control panel 116 to send a signal to the solenoid valve 114 for that inflatable bladder 108 to move into a configuration that closes the fluid flow path between the compressed air system 107 and the inflatable bladder 108 while keeping its vent closed as well.

The target pressure (that indicates the inflatable bladder 108 is sufficiently full) can be any one of a variety of possible pressures, but is typically less than 120 pounds per square inch (psi). In some implementations, the target pressure is the pressure at which the inflatable bladder 108 fills, or at least substantially fills, any otherwise empty space above any liquid that is inside the liquid storage compartment 106. By filling, or substantially filling, this otherwise empty space, the inflated inflatable bladder 108 can eliminate, or substantially minimize, any undesirable surging or sloshing of liquid inside the liquid storage tank 102 as the vehicle moves about (and stops and starts).

In a typical implementation, the pressure sensors 118 are able to communicate with the control box 116. Once the target pressure inside an inflatable bladder 108 is reached, and the pressure sensor 118 inside the inflatable bladder 108 senses that the target pressure has been reached, the pressure sensor 118 sends a shut-down signal, wirelessly or over a wired connection (not shown in the figure) to the control box. In response to the shut-down signal, the control box 116 causes the associated solenoid valve 114 to move into a closed configuration, where the solenoid valve prevents any air from moving into or out of the now-inflated, inflatable bladder 108.

Continuing this example, if the user subsequently moves the rocker switch associated with the now-inflated, inflatable bladder, to a “deflate” position, the control box 116 causes the associated solenoid valve 114 to move into a venting configuration, in which the vent for that solenoid valve opens and allows air from inside the inflatable bladder 108 to escape to the atmosphere, while preventing any additional air from the compressed air system from entering the inflatable bladder 108.

In some implementations, the pressure sensor 118 inside the deflating inflatable bladder 108 will monitor pressure inside that bladder 108 and send signals to the control panel 116 while the inflatable bladder 108 is deflating. In some such implementations, deflation (e.g., venting through the open vent of the solenoid valve 114) continues until the pressure in that inflatable bladder 108 reaches some predetermined value (e.g., a target deflated pressure, that may have been programmed into computer-based memory within or accessible from the control panel 116). If the computer-based processor (e.g., within or in communication with the control panel 116) determines that the pressure inside one of the inflatable bladders 108 has reached the predetermined value (e.g., target deflated pressure), the processor causes the control panel 116 to send a signal to the solenoid valve 114 for that inflatable bladder 108 to move into a configuration that closes the vent, also leaving the fluid flow path between the compressed air system 107 and the inflatable bladder 108 closed as well.

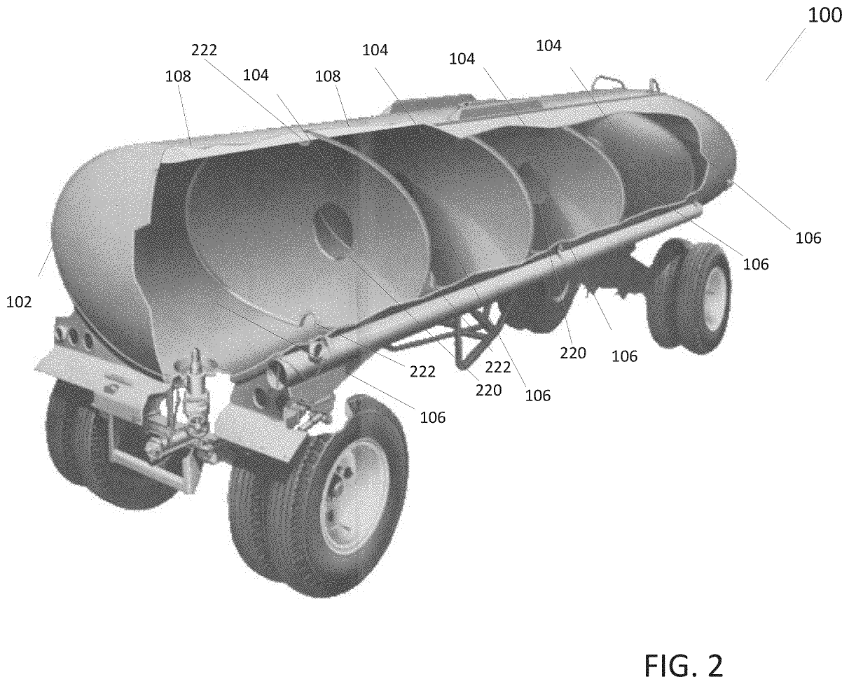

It is possible that, over time, one or more of the inflated inflatable bladders 108 may lose some of its air (e.g., by leakage or the like). If that happens, the pressure in the leaking inflatable bladder 108 goes down. The pressure sensor 118 in the leaking inflatable bladder 108 senses the drop on pressure and sends a signal to the control panel 116 of the sensed pressures. In some such implementations, the system 101 is configured to deliver a fresh charge of air (from the compressed air system 107) into the leaking inflatable bladder 108 to make up for lost air. In those implementations, if the computer-based processor (e.g., within or in communication with the control panel 116) determines that the pressure inside one of the inflatable bladders 108 has reached a predetermined value (e.g., target air-loss pressure), the processor causes the control panel 116 to send a signal to the solenoid valve 114 for that inflatable bladder 108 to move into a configuration that opens the fluid flow path between the compressed air system 107 and the inflatable bladder 108 closed, while leaving the vent for that solenoid valve 114 closed. Once the computer-based processor determines that the pressure inside the inflatable bladder 108 has been restored (to some predetermined value stored in computer-based memory), the processor causes the control panel 116 to send a signal to the solenoid valve 114 for that inflatable bladder 108 to move into a configuration that closes the fluid flow path between the compressed air system 107 and the inflatable bladder 108 closed, while leaving the vent for that solenoid valve 114 closed. FIGS. 2-5 show perspective views, partially in cross-section, of part of the vehicle 100 represented in FIG. 1, with different amounts of liquid in the liquid storage tank 102, and with the inflatable bladders 108 inflated to different degrees. More specifically, these figures show a trailer portion of the vehicle 100. The trailer portion of the vehicle 100 has wheels and is configured to be hauled on a road by a tractor unit for example.

The partial cross-sectional portions of these figures reveal certain internal details of liquid storage tank 102.

For example, the partial cross-sectional portions of these figures reveal that the liquid storage tank 102 has internal surfaces that are substantially oblong in cross-section about a longitudinal, horizontal axis of the vehicle.

Moreover, the partial cross-sectional portions of these figures provide a detailed perspective view of some of the internal baffles 104. As illustrated, each internal baffle is slightly curved to define a concave forward-facing surface and a convex rearward-facing surface. The internal baffles 104 laterally dissect the liquid storage tank 102 and are pretty evenly spaced so that each internal compartment 106 (i.e., the spaces between adjacent baffles 104, the space between the forward-most baffle and the front of the liquid storage tank 102, and the space between the rearward-most baffle and the rear of the liquid storage tank 102) is about the same size as the others.

In various implementations, any or all of the baffles 104 can have one or more or no openings or notches that allow some amount of liquid to flow between adjacent compartments 106 within the liquid storage tank 102. For example, the forward-most baffle in the illustrated implementation has a centrally-disposed opening 220 and notches 222 at the top and bottom of the baffle 104 that provide fluid flow openings between adjacent internal compartments 106. Other types of openings, notches, etc. may be formed in any one or more of the baffles 104 in a particular implementation. Moreover, the size, shape, number and/or configuration of openings or notches in the different baffles 104 in a particular system can vary or be the same. In a typical implementation, aside from any notches that a particular baffle might have at its edge, the baffles 104 otherwise extend entirely to the internal, substantially oblong surface of the liquid storage tank 102—to contact and seal against that internal, substantially oblong surface.

The inflatable bladders 108 are inside each of the liquid storage compartments 106.

FIG. 2 shows the inflatable bladders 108 in a completely deflated configuration. This completely deflated configuration may be appropriate if, for example, the liquid storage tank 102 has no, or very little, liquid inside of it. Alternatively, this completely deflated configuration may be appropriate if the liquid storage tank 102 is completely full of liquid so that there is virtually no room in any of the internal compartments 106 for the inflatable bladders 108 to inflate and the risk of hazard from sloshing or surge from the liquid inside the liquid storage tank 102 is low.

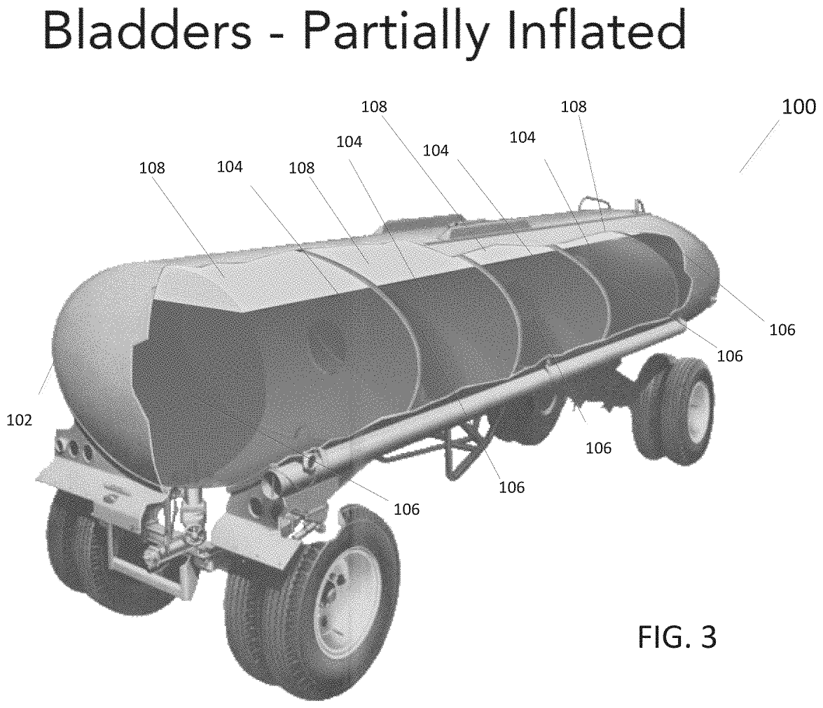

FIG. 3 shows the inflatable bladders 108 in a partially inflated configuration. The liquid storage compartment in FIG. 3 is almost full of liquid and the inflated bladders 108 fill the otherwise empty space above the liquid inside each liquid storage compartment 106. In a typical implementation, the inflatable bladders may be oval or balloon-shaped for example. Since the inflatable bladders 108 are made of a flexible material, when the inflatable bladder 108 expands to contact and press down on the upper surface of liquid inside the liquid storage compartment 106, the shape of the bladder begins to change and roughly conform to the relatively flat, horizontal upper surface of the liquid inside the liquid storage compartment, and to the curved inner surfaces of the liquid storage tank 102.

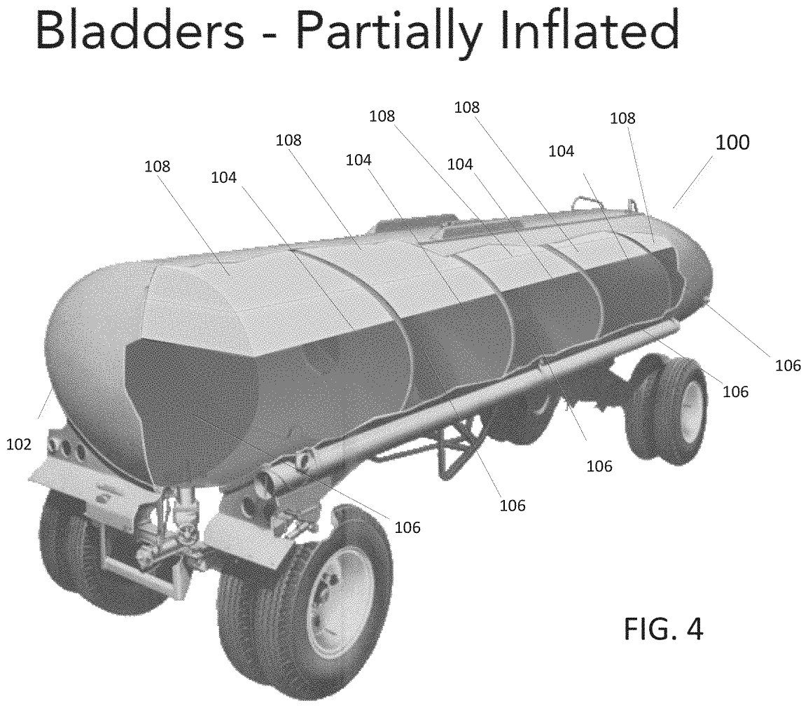

FIG. 4 shows the inflatable bladders 108 in a slightly more inflated configuration than in FIG. 3, but still not completely inflated. The liquid storage compartment in FIG. 4 is more than halfway full of liquid and the inflated bladders 108 fill the otherwise empty space above the liquid inside each liquid storage compartment 106.

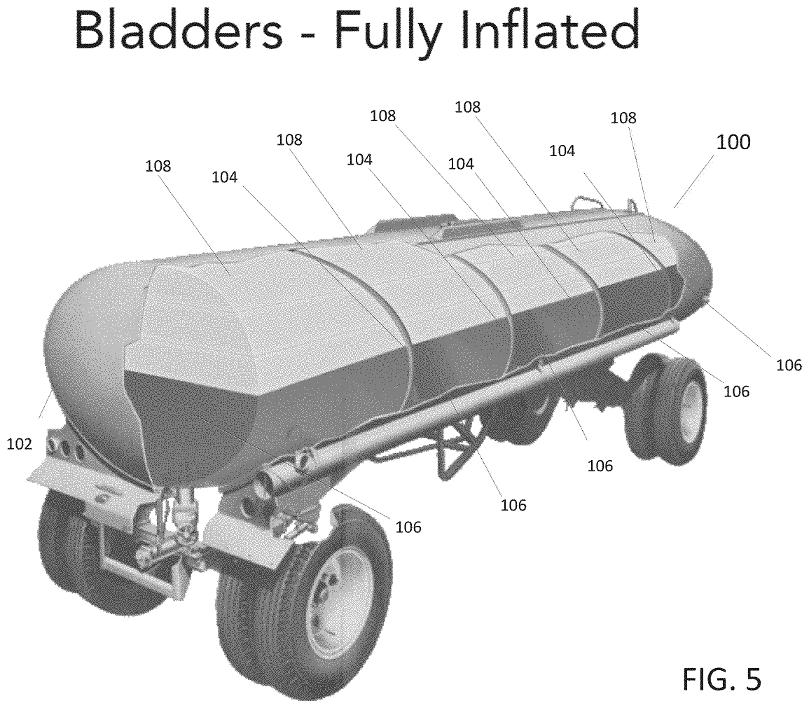

FIG. 5 shows the inflatable bladders 108 in a completely inflated configuration. The liquid storage compartment in FIG. 5 is about halfway full of liquid and the inflated bladders 108 fill the otherwise empty space above the liquid inside each liquid storage compartment 106.

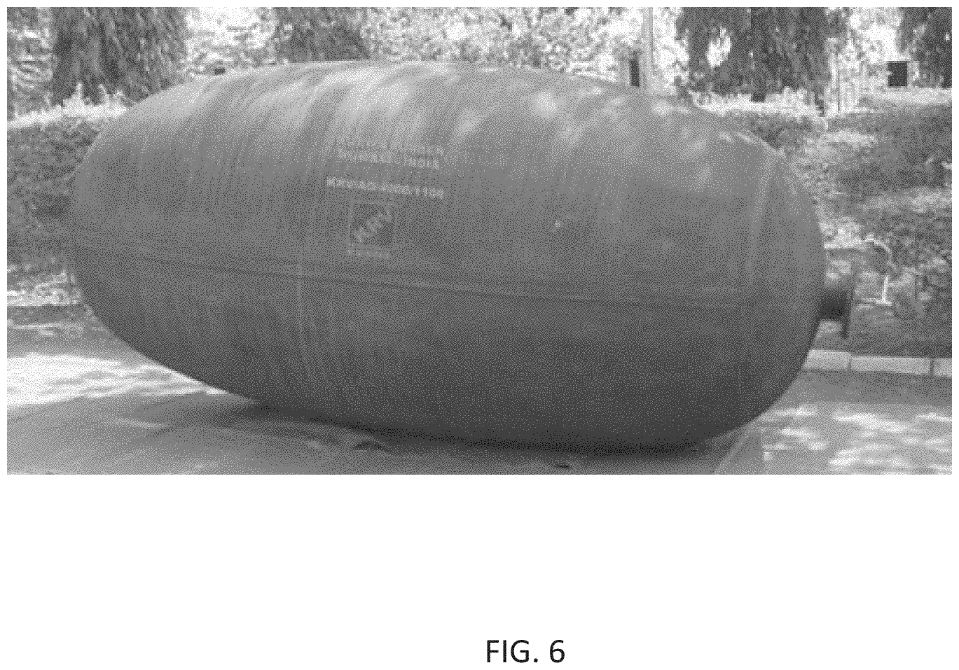

FIG. 6 is a side perspective view showing an example of what a stand-alone one of the inflatable bladders 108 can look like. The illustrated inflatable bladder 108 is approximately pill-shaped. In a typical implementation, the inflatable bladder 108 is made from a light, strong, flexible, and highly collapsible material.

The inflatable bladder 108 is made from a material suitable for use in whatever environment the inflatable bladder 108 is intended to be used. One possible material that the inflatable bladder 108 may be made from is the same type of material as a Petro-Flex® fuel bladder, available from ATL® (Aero Tec Laboratories). This material would make the inflatable bladder 108 be appropriate for use in connection with hauling a wide range of petroleum products including, for example, gasoline, diesel, jet fuel, lube oil, crude oil, heating oil, etc.—in some cases, all fuels. This material is light, strong, flexible, and highly collapsible. Different materials may be used in other applications. For example, if the liquid to be hauled is going to be a consumable liquid, such as milk, the material should be one that won't contribute any flavor to the liquid if or when it comes into contact with the liquid. In some implementations, the bladder material is rip-stop nylon and may include a polyurethane coating. This may provide for excellent waterproofing, durability, and be relatively light in weight.

In a typical implementation, the bladder can be thought of as performing the “work” of keeping the liquid load stabilized, as well as filling up any “empty” space in the compartment, essentially making any partially full compartment into a full compartment. It is much safer to transport liquid with a full compartment as compared to a partially full compartment.

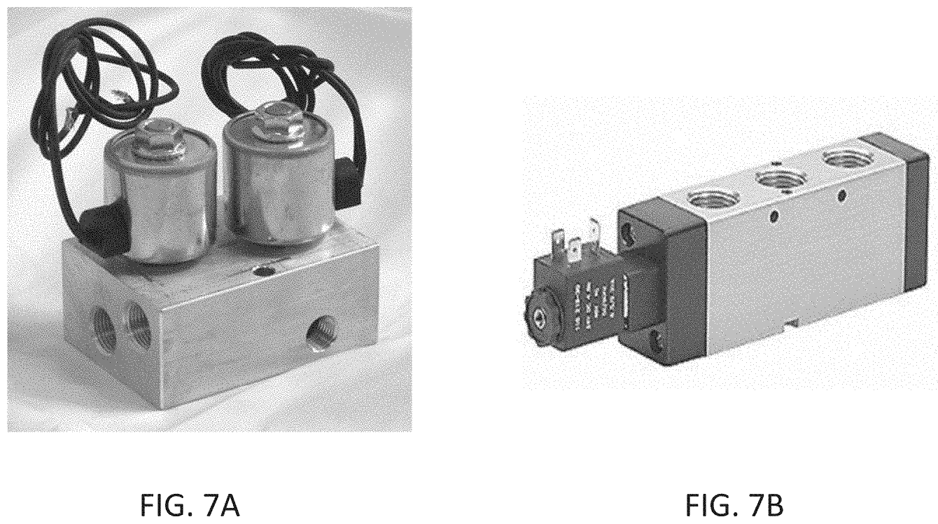

FIG. 7A is a perspective view showing one exemplary implementation of one of the solenoid valves 114 from the system of FIG. 1. The exemplary solenoid valve 114 has a compact manifold that is machined from billet aluminum for easy fitting and easy plumbing. It has ⅜″ ports for airflow and two separate solenoids—one for inflating, one for deflating. The solenoid valve 114 shown in FIG. 7A is available from the AirRide company in the United Kingdom.

FIG. 7B is a perspective view showing an alternative exemplary implementation of one of the solenoid valves 114 from the system of FIG. 1. The exemplary solenoid valve is a ½″ 24 VDC, 3-Way/2-Position Solenoid Air Control Valve.

Of course, a wide variety of solenoid valves 114 may be suitable for use in the system of FIG. 1; FIGS. 7A and 7B shows but two such possibilities.

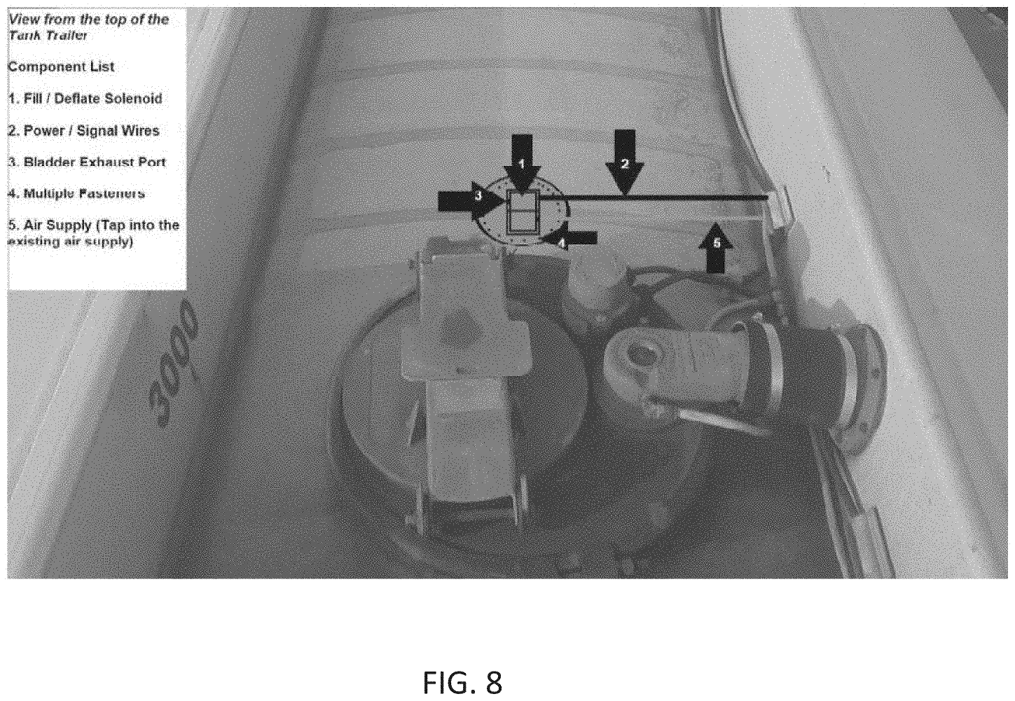

FIG. 8 is a perspective view showing part of the upper, outer surface of the liquid storage tank 102 from the system of FIG. 1. The view shows an access manhole for one of the liquid storage compartments 106 inside the liquid storage tank 102, and the solenoid valve 114 for the inflatable bladder inside that liquid storage compartment 106. The view shows the following components, which are numbered in the figure: 1) solenoid valve, 2) power/signal wires for the solenoid valve, 3) the bladder exhaust port, 4) fasteners, and 5) an air supply line (that taps into the vehicle's compressed air system).

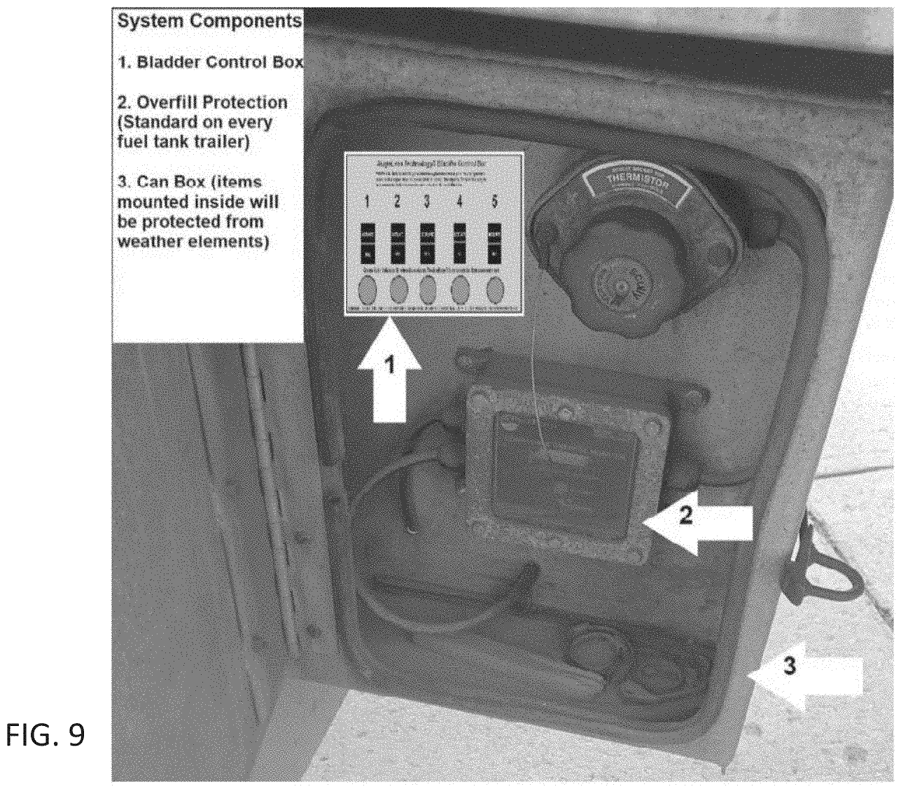

FIG. 9 is a perspective view of a can box for the vehicle represented in FIG. 1. The illustrated can box includes: 1) a bladder control box (or control panel) 116 (with the user interface for inflating or deflating the bladders), 2) overfill protection and 3) the can box housing, which protects internal elements from the weather. In many cases, it will be a good idea to install the bladder control box 116 here because you can use the existing wire paths as well as keep the electronics safe from the weather.

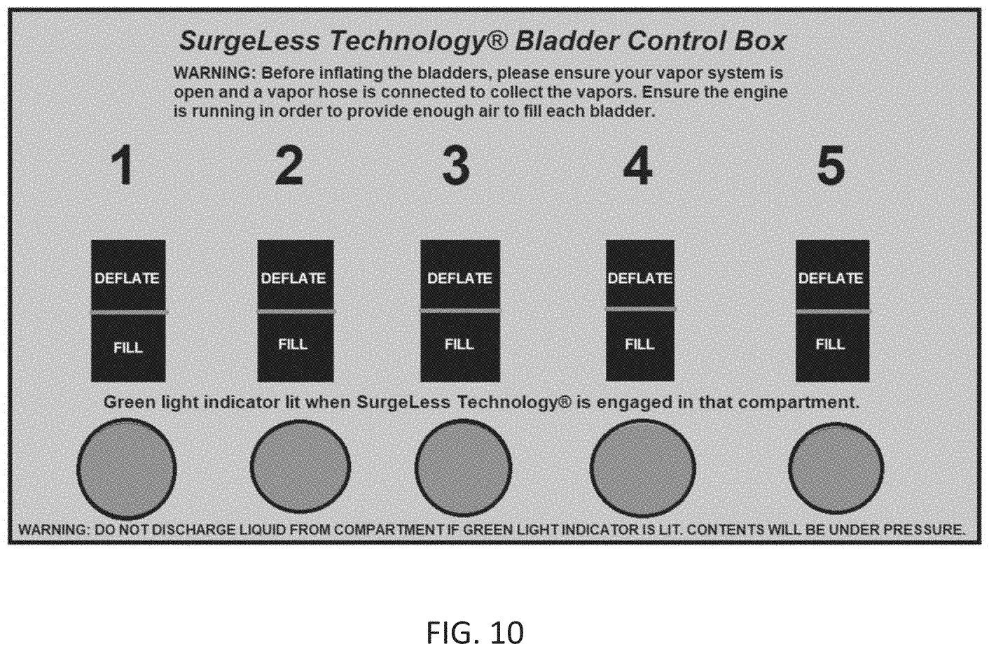

FIG. 10 shows an example of what the user interface of the bladder control box 116 might look like. The Control box may come in a few variations, depending on the amount of compartments the tank has. The control box is made to be simple, easy to use, and easy to reach for the user. It can be mounted next to the Scully indicator box in some cases. Otherwise it can be mounted in a can box. The user interface has fill/deflate rocker switches, and visual indicators that indicate when a bladder has been inflated in one or more of the compartments.

In some implementations, system installation might include the following steps (not necessarily performed in this order): 1) tap into the vehicle's main air supply (usually regulated to 120 psi) using a single splitter, 2) run an airline from the splitter up into the rail in the walkway on the roof of the tank (each compartment may need an additional splitter to supply air to the inflation valve), 3) mount the control box inside of a can box, preferably next to the Scully system, and 4) run the wires from the control box up into the rail in the walkway on the roof (may be able to use the same wire path as the Scully to probe wires).

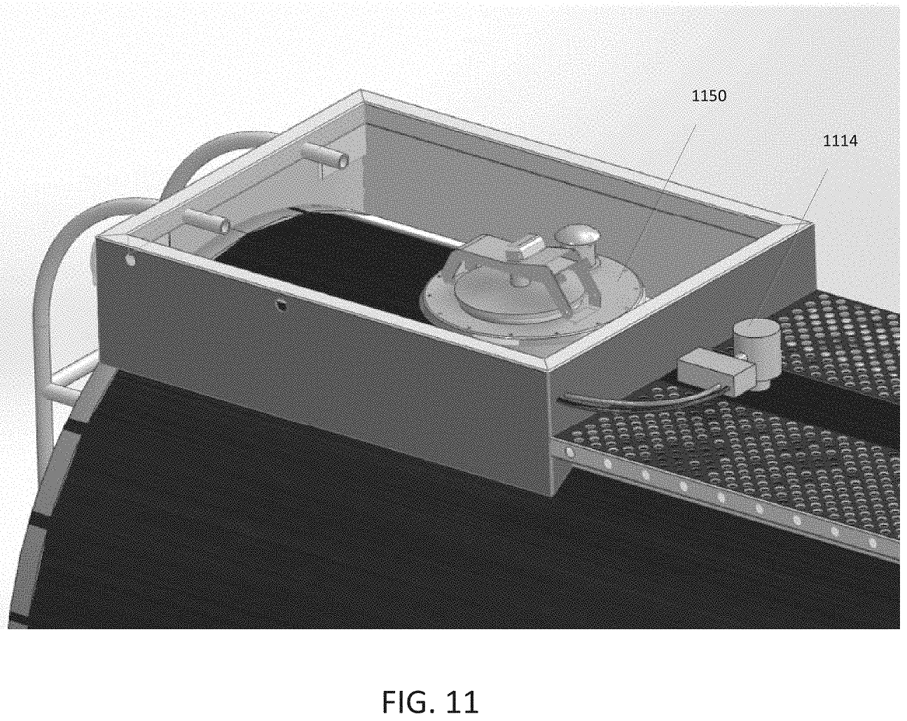

FIG. 11 is a perspective view showing an upper surface of a tank trailer.

The illustrated implementation shows a manhole cover 1150 and a solenoid valve 1114 atop the tank. Since the solenoid 1114 has the bladder attached to the bottom of it (on the inside of the tank), there needs to be a way to access the connection points. Having the manhole access close by gives adequate access for technicians to install and service the bladders.

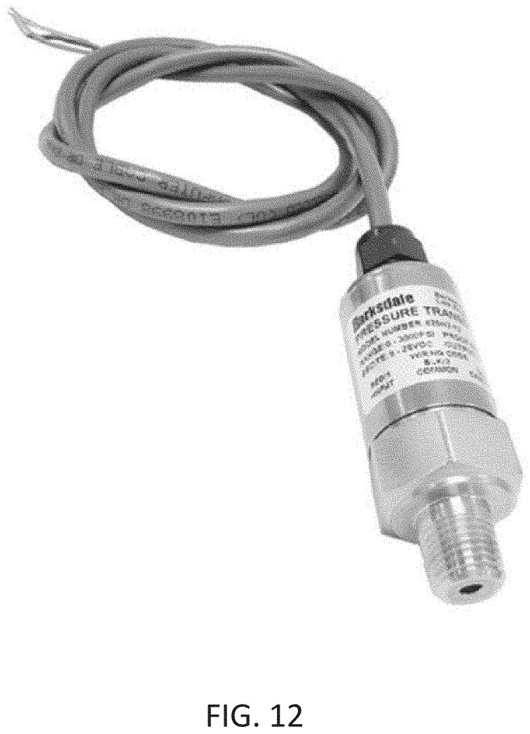

FIG. 12 is a perspective view showing one implementation of a pressure transducer for sensing pressure inside the inflatable bladders 108.

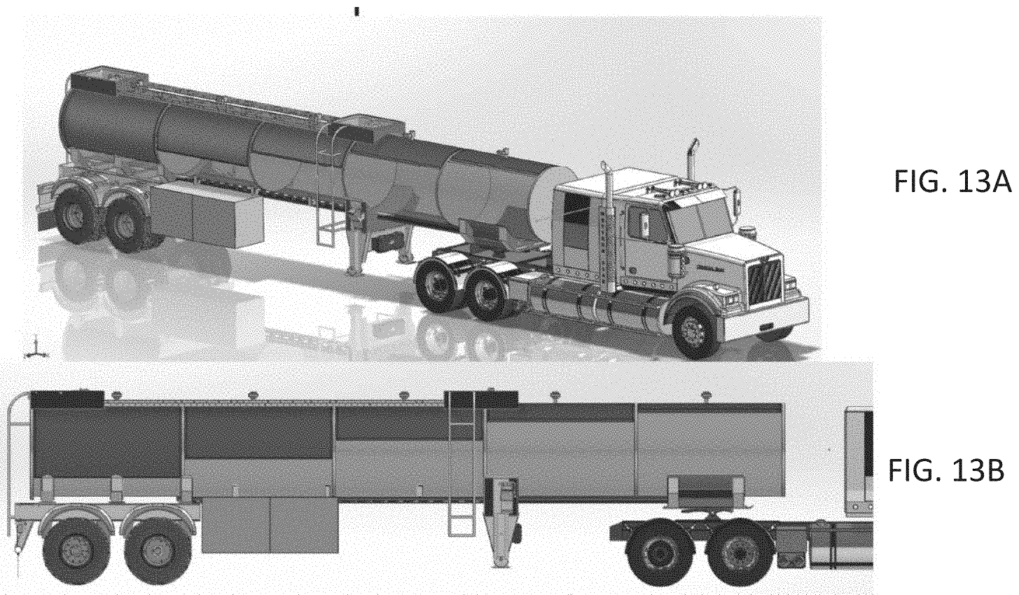

FIG. 13A is a partially-transparent, perspective view of a vehicle assembly that includes a bulk liquid storage tank. FIG. 13B is a partially-transparent, side view of the vehicle assembly in FIG. 13A.

A number of embodiments of the invention have been described. Nevertheless, it will be understood that various modifications may be made without departing from the spirit and scope of the invention.

For example, the liquid storage tank can be divided internally by any number of baffles into any number of discrete liquid storage compartments. The internal compartments need not be the same size as one another. The internal compartments (i.e., the spaces between adjacent baffles) need not be the same size or shape as one another. In some implementations, there are no internal baffles. If there are no baffles, the liquid storage tank may include one internal space and one bladder inside that one internal space.

The absolute and relative size, shape and capacity of each system component can vary.

Any of the communications mentioned herein could be implemented over wired or wireless connections.

The pressure sensors can be virtually any kind of pressure sensors. The compressed air system can vary considerably from what is disclosed herein. The specific configuration of the user interface can vary considerably. The relative positioning of some of the system components can vary.

The pressure sensors do not need to be inside the inflatable bladders. As long as they are in fluid communication with the inside of the inflatable bladders so that they can effectively sense pressure inside the inflatable bladders during inflation, other configurations may be possible. For example, the pressure sensors could be built into solenoid valves (e.g., near or in the solenoid valve outlet ports).

The solenoid valve can be virtually any kind of solenoid valve, or any other kind of valve. In some implementations, the valves can be controlled by something other than a solenoid. For example, the valves can be controlled by air pressure, or hydraulic pressure. In some implementations, the valves can be controlled manually. If the valves are to be controlled manually, the system typically would include a pressure indicator near the valve to indicate the real time pressure inside the associated inflatable bladder and/or a pressure alarm (audible, tactile, and/or visual, etc.) that can indicate to the user operating the manual valve when the target pressure inside the associated inflatable bladder has been reached.

The systems and techniques disclosed herein can be used in a variety of different types of liquid transport applications including in an oil/gas tanker, and smooth bore tank trailers commonly used for transporting food grade products, chemicals, and water.

Moreover, while this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of subcombinations.

Similarly, while operations are described herein as occurring in a particular order, this should not be understood as requiring that such operations be performed in the particular order disclosed or in sequential order, or that all such operations be performed, to achieve desirable results.

Other implementations are within the scope of the claims.

What is claimed is:

1. A system comprising:
a liquid storage tank;
one or more liquid storage compartments inside the liquid storage tank;
an inflatable bladder inside each of the liquid storage compartments;
a compressed air system to provide compressed air to inflate each one of the inflatable bladders; and
one or more valves, wherein each of the valves is configured to control air flow between the compressed air system and a corresponding one of the inflatable bladders and/or to control air flow between the corresponding inflatable bladder and atmosphere.

2. The system of claim 1, further comprising:
a pressure sensor to sense pressure inside each of the inflatable bladders.

3. The system of claim 1, wherein the pressure sensors provides signals to a control panel indicative of the pressure being sensed.

4. The system of claim 3, wherein if the system is delivering compressed air into a particular one of the inflatable bladders, delivery continues until the pressure sensed by the pressure sensor for that inflatable bladder reaches some predetermined value, at which point the control panel sends a signal to cause the valve for that inflatable bladder to move into a configuration that closes a fluid flow path between the compressed air system and the inflatable bladder and closes or keeps closed a vent on the valve as well.

5. The system of claim 1, wherein each of the valves is a solenoid valve.

6. The system of claim 1, further comprising:
a control panel with a user interface that enables a human user to selectively inflate or deflate any one or more or all of the inflatable bladders.

7. The system of claim 6, wherein the user interface comprises a “fill/deflate” switch or button for each inflatable bladder that the user can manipulate to inflate or deflate that inflatable bladder with air from the compressed air system.

8. The system of claim 7, wherein each of the valve is a solenoid valve, and wherein the control box is configured to send electrical signals to each of the solenoid valves in response to the human user manipulating the “fill/deflate” switch or button.

8. The system of claim 1, further comprising:
a plurality of baffles inside the liquid storage tank, wherein the baffles divide the liquid storage tank longitudinally into a plurality of the liquid storage compartments.

9. The system of claim 8, wherein each respective one of the liquid storage compartments has a corresponding one of the baffles, and a corresponding one of the valves.

10. The system of claim 1, further comprising:
a vehicle configured to haul the system.

11. A system comprising:
a vehicle; and
a liquid storage system coupled to the vehicle, wherein the liquid storage system comprises:
a liquid storage tank;
a plurality of baffles inside the liquid storage tank, wherein the baffles divide the liquid storage tank longitudinally into a plurality of liquid storage compartments, an inflatable bladder inside each of the liquid storage compartments;
a compressed air system configured to provide compressed air to inflate the inflatable bladders;
a plurality of solenoid valves, wherein each solenoid valve is configured to control air flow between the compressed air system and a corresponding one of the inflatable bladders and/or to control air flow between the corresponding inflatable bladder and atmosphere; and
a controller with a user interface that enables a human user to selectively inflate or deflate any one or more or all of the inflatable bladders.

12. A method comprising:
providing a liquid bulk transport vehicle with a system that comprises:
a liquid storage tank;
one or more liquid storage compartments inside the liquid storage tank;
an inflatable bladder inside each of the liquid storage compartments;
a compressed air system to provide compressed air to inflate each one of the inflatable bladders; and
one or more valves, wherein each of the valves is configured to control air flow between the compressed air system and a corresponding one of the inflatable bladders and/or to control air flow between the corresponding inflatable bladder and atmosphere;
introducing a liquid into one or more of the liquid storage compartments of the liquid storage tank of a liquid bulk transport vehicle; and
inflating one or more inflatable bladders inside the liquid storage tank to a target pressure.
